(19) United States
(12) Patent Application Publication
(10) Pub. No.: US 2024/0075486 A1
(43) Pub. Date: Mar. 7, 2024

(54) REFILLABLE CONTAINER-DISPENSER SYSTEM WITH TRIGGER SPRAYER AND CLOSURE

(71) Applicant: RIEKE LLC, Auburn, IN (US)

(72) Inventor: Anthony ANGELOZZI, Fort Wayne, IN (US)

(21) Appl. No.: 18/273,797

(22) PCT Filed: Feb. 16, 2022
(86) PCT No.: PCT/US2022/016526

§ 371 Date: Jul. 24, 2023

Related U.S. Application Data
(60) Provisional application No. 63/149,710, filed on Feb. 16, 2021.

(51) Int. Cl. B05B 11/00

(52) U.S. Cl. CPC B05B 11/0097; B05B 11/0008; B05B 11/1011

(57) ABSTRACT

A refillable container system having an integrated dispenser, refilling funnel, and closure is contemplated. The closure is configured to attach to any type of standardized container, while the funnel is selectively attachable to the container/closure and includes threads or coupling features along the inner facing of its attachment end. The closure also accommodates a trigger sprayer or other types of dispensers. When so configured, the system allows for dispensing and refilling fluids with a cohesive set of components that may all be carried on the container.

### CROSS REFERENCES TO RELATED APPLICATIONS

The present application claims priority to U.S. provisional patent application 63/149,710 filed on Feb. 16, 2021, which is incorporated by reference herein.

### TECHNICAL FIELD

The present invention relates generally to a system or combination having container with a closure, a trigger sprayer, and an integrated funnel selectively attachable and carried integrally on the closure and/or container. More specifically, the closure includes a neck piece having cooperating threads to receive and couple to the funnel, such that the neck piece is snap-fitted onto a standard-sized, and preferably metallic, container.

### BACKGROUND

As described in U.S. Pat. No. 10,696,529, funnels or spouts are often included with container systems to simplify the transfer of liquids from the container. Such funnels are particularly useful in the in the automotive area, where fuel additives, oil, lubricants, and/or other viscous liquids must frequently be delivered into vertically oriented ports of a defined size. Thus, by including a spout or funnel, the user can direct the flow and leave the arrangement in an inverted position for an extended period of time to ensure the entire amount of liquid is transferred.

Funnel-like attachments have also been suggested to simplify the filling (or refilling) of containers for carrying medications, paints, and/or other substances. United States Patent Publication 2020/0102136 contemplates an insert, carried internally within an extended/elongated portion of the container neck, that appears to have a frusto-conical taper to guide tablets in the container toward the opening as they are being dispensed. This insert is configured to create and accommodate an induction sealing surface when it is first fitted into the container, as well as to potentially define a chamber that is separated from the tablets so as to store a separate substance (e.g., an RFID/NFC tag).

U.S. Pat. No. 3,537,623 shows a frusto-conical funnel having internal threads formed on its inner facing proximate to its mouth (i.e., the wider opening of the funnel), along with a cross brace dividing the inner volume of the funnel and external threads at the dispensing end. The external threads accommodate a closure cap, while the internal threads couple to the annular protrusion or flange formed by standard crimp-sealing of metallic containers. In this manner, the funnel is attached to the container, but with its dispensing end positioned upward so as to facilitate the dispensing of fluid from the container to which it is attached.

United States Patent Publication 2016/0376073 describes an inverting dispenser spout formed within a container lid. When not in use, a disposable lid is positioned over the spout, which itself protrudes into the inner volume of the container.

U.S. Pat. No. 9,107,537 contemplates a “refillable, multi-dose container” which actually attaches to a separate vessel storing flowable products such as beverage concentrates. The attachment allows for filling and dispensing of dosed amounts from the refillable portion, but that portion is itself necessarily carried on the vessel.

Finally, United States Patent Publication 2004/0245204 teaches a bottle having an adapter. The adapter is configured to cooperate with a latching projection and an orientation projection on the bottle neck. The adapter itself serves the purpose of improving mechanical strength for assembling the bottle and closure, especially with regard to pre-centering the components.

In view of the foregoing, a container system having a refilling funnel attachment would be welcomed, especially to the extent the funnel was not required to occupy internal volume in the container itself. Further, a simple and standardized closure that could be fitted to the container to reliably and securely couple the refilling funnel to the container would be welcome. Lastly, to the extent such a refilling system further included dispensing options such as a trigger sprayer, such a combination would be welcomed.

### SUMMARY OF INVENTION

A versatile, refillable container and dispensing system is contemplated. A container (preferably metallic) having a standard-sized neck finish/opening is fitted with a polymeric closure element. The closure element snap-fits to the container and includes a frangible panel that seals and serves as an initial indicator of tamper evidence. Exterior threads on the closure selective attach to a cap, a trigger sprayer (or other dispensing means), and a special funnel. The funnel includes threads on its inner surface at its narrowed end. Further accommodations to the funnel ensure that it can be tethered to the container neck immediately beneath the closure and/or that the cap may be coupled to either the funnel or the dispenser when the cap is not screwed onto the container.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

One particular aspect of the invention is a dispensing system with a refillable container and a closure element may include any combination of the following features:
a refill funnel having a mouth at a top end with a wider inner diameter in comparison to a neck at a bottom end, wherein a cooperating attachment feature disposed on an inner surface of the neck and configured to selective couple to the attachment feature of the closure element;
a dispensing element having a cooperating attachment feature selectively coupling to the attachment feature of the closure element;
wherein the refill funnel includes an integrally formed attachment ring, said attachment ring captured on the neck by the closure element;
wherein the attachment feature and the cooperating attachment features comprise a rotatable, threaded connection;
wherein the dispensing element is at least one selected from the group consisting of: a trigger sprayer, a dispensing funnel, and a dosing cup;
wherein the closure element includes a hollow cylindrical top section with threads disposed on an outer surface;
wherein the closure element includes a flange at an opposite end from the top section and wherein the flange includes an annular recess configured to couple to the neck;
wherein a removable panel spans an inner diameter of the closure so as to seal the container when the closure is coupled to the container;
wherein the removable panel is circular, oval, or polygonal;
wherein a finishing edge is formed at a periphery of the removable panel;
wherein the periphery of the removable panel includes a tether hinge and a frangible arcuate section;
wherein a handle is attached to the removable panel;
wherein the periphery of the removable panel includes a tether hinge and a frangible arcuate section; and
wherein the closure element includes one or more ribs formed on a top facing of the top section and wherein a terminal edge of the neck is crimped or curled around the one or more ribs to couple to the closure to the container.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure. Also, the objects in the drawings are shown in their intended orientation, so that a feature shown in the top of the drawings are oriented toward the upper or topside portion of the mechanism/object, while features at or facing downward likewise at the bottom or underside portion.

In the drawings and attachments, all of which are incorporated as part of this disclosure:

FIG. 1 is a three dimensional, top perspective view of the system and combination according to one aspect disclosed herein.

FIG. 2A is a three dimensional, top perspective view isolated to show the attachment of the funnel to the closure and container, with a cap affixed to the container. FIG. 2B is a corresponding view to that of FIG. 2A but with the cap removed (and not shown) and the funnel coupled to the container, with a further partial cross sectional view of a one quarter section of the funnel and closure removed.

FIG. 3 is a three dimensional, top perspective view of isolated components usable in the system and combination according to various aspects disclosed herein.

FIG. 4 is a three dimensional, top perspective view isolated to show the closure (in its original condition) coupled to the container, with a further partial cross sectional view of a one quarter section of the closure and container.

FIG. 5 is a cross sectional plan view of the closure component (in its original condition) taken along its diameter.

FIG. 6 is a three dimensional, top perspective view isolated to show the attachment of the funnel to the closure, with a further partial cross sectional view of a one quarter section of the funnel and closure removed, thereby highlighting the handle of the tamper-evident diaphragm of the closure (in its original condition) and the threaded attachment of the funnel to the closure, as well as the stopping flange of the funnel in its flushed position with the top edge of the closure.

FIG. 7 is a cross sectional side view showing an alternative for attachment of the closure to the container neck.

FIG. 8A is a three dimensional, perspective, cross sectional view of a diameter of the closure incorporating a tethered hinge and further illustrating how a piercing element, such as the dip tube of a trigger sprayer, can be inserted and used relative to the tethered hinge. FIG. 8B shows the same cross section as in FIG. 8A, but in plan view and further isolating only the closure so as to better highlight features of the top panel of that closure.

FIG. 9A is a top plan view and FIGS. 9B (top) and 9C (bottom) are complimentary, sectional three dimensional perspective views of the top panel and tethered hinge portions of the closure of FIG. 8A.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

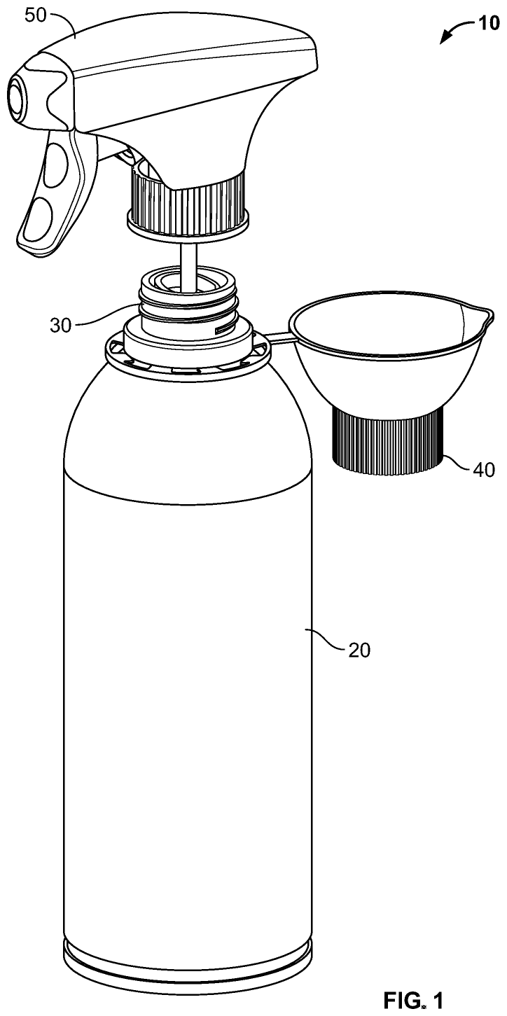

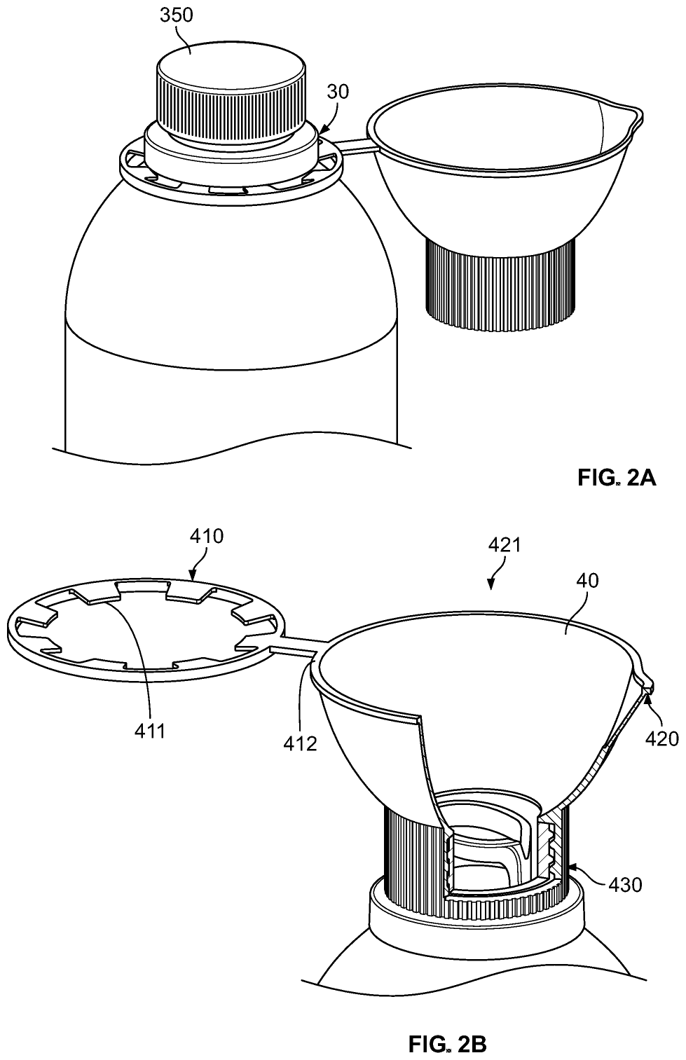

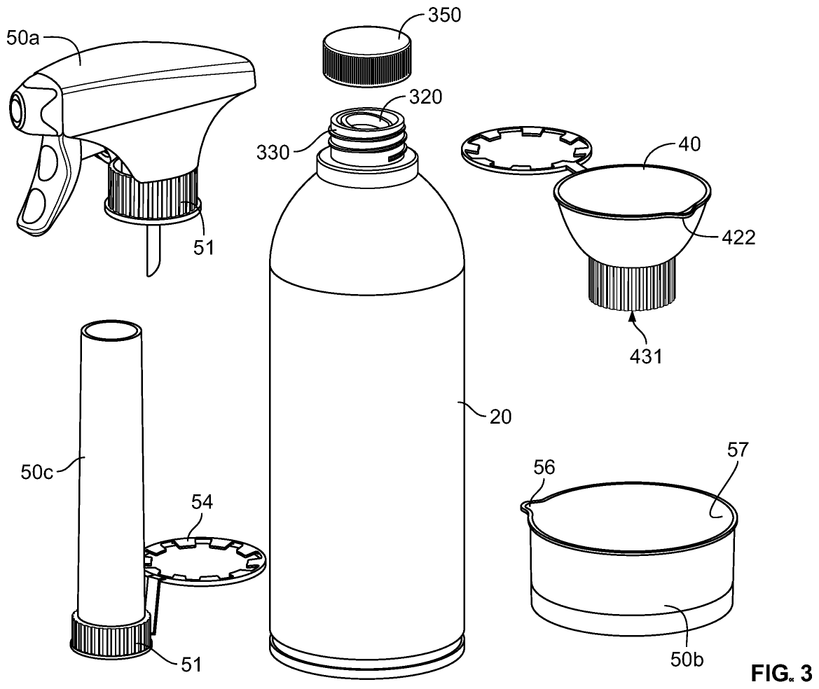

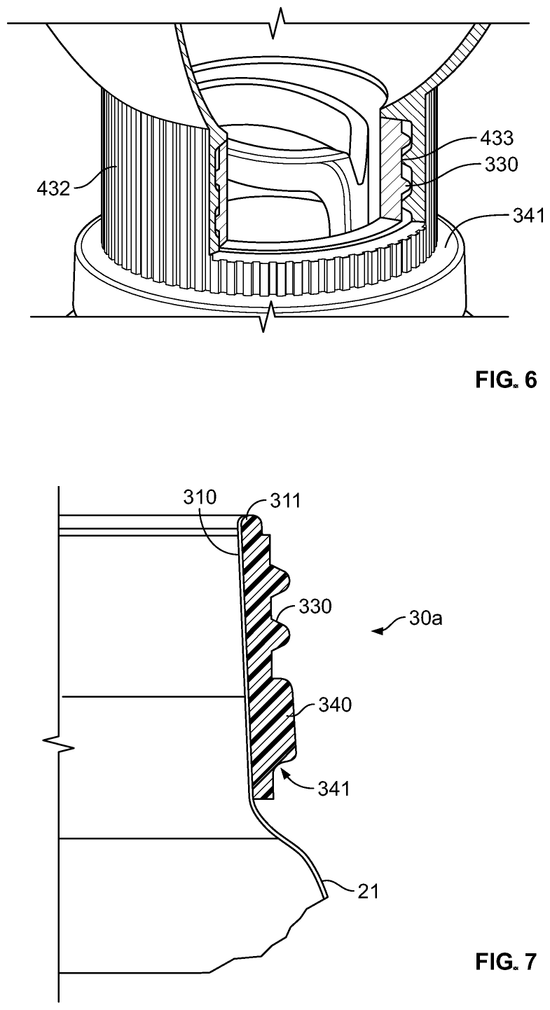

With reference to FIGS. 1 through 8C, a container and dispensing system 10 comprises a plurality of cooperating and attachable components: container 20, closure element 30, refilling funnel 40, and dispensing elements 50 (specifically shown as 50a, 50b, and 50c in FIG. 3). The entirety of the arrangement is such that all of these elements may be selectively coupled to the container 20 as described below, thereby providing a dispensing system that can be refilled (via the funnel 40) while conveniently ensuring a means to keep all of the components coupled together. The use of other known dispensing elements, including but not limited to a reciprocating dispenser pumps (such as those in background and drawings of U.S. Pat. Nos. 8,827,121 and 8,960,507, incorporated by reference), other trigger sprayers (such as those in background and drawings of U.S. patent application Ser. No. 17/047,148, originally published as international application WO2019/00380 and incorporated by reference), and/or measured dosing dispensers (such as those in the background and drawings of U.S. Pat. No. 9,433,960, incorporated by reference), are also embraced by certain aspects of this invention.

Container 20 is a hollow cylinder that is closed at its bottom end, open at its top, and configured to carry fluids for dispensing, such as soaps, oils, aqueous or non-aqueous solutions, and other similar fluids. The open top end includes a neck 21 in which the diameter or cross section of the cylinder gradual tapers, although this section could be provided as a separate cylinder of reduced diameter (e.g., such as might be found on an F-style container).

A protrusion or flange 22 is formed at the terminal edge of the sidewall in the neck 21. Flange 22 may be bulbous or otherwise imparted with a cross-sectional profile that cooperates with snap-fitting features formed on the closure, as will be described in greater detail below.

Advantageously, container 20 may be a standard-sized vessel similar to any number of such containers currently used in the industry. In one example, the container 20 may be formed from metal or treated so that its interior is not corroded or degraded by the fluids it carries.

A closure element 30 is mounted onto the neck 21 and/or the flange 22. Closure element 30 includes an outer surface that serves as an interface to accommodate the other components of the system 10. Element 30 is a hollow cylinder open at both ends. The lower end includes a flange 340 imparting a larger outer diameter in comparison to that at the top or dispensing end 310. An annular groove may be provided in the bottom facing of the flange section 340 to receive and snap fit to the flange 22. Threads 330 are provided on the outer surface of the top end 310 to allow coupling a cap 350 or any number of dispensing elements 50 thereto.

In one aspect, the sidewall defining top end 310 extends below the top panel 341 of flange section 340, thereby forming a tubular extension 342. Reinforcing ribs 343 may be positioned in substantially annular direction (i.e., parallel to the central axis of the cylinder forming element 30), preferably at regular circumferential intervals. Ribs 343 extend beneath panel 321 and may have a tapered thickness and/or width which diminishes as the ribs 343 extend away from the panel 321. In this manner, ribs 343 provide improved strength so as to accommodate and simplify detaching the tamper evident panel 321 that is attached to and removed by the bail handle 320 (as will be described in greater detail below).

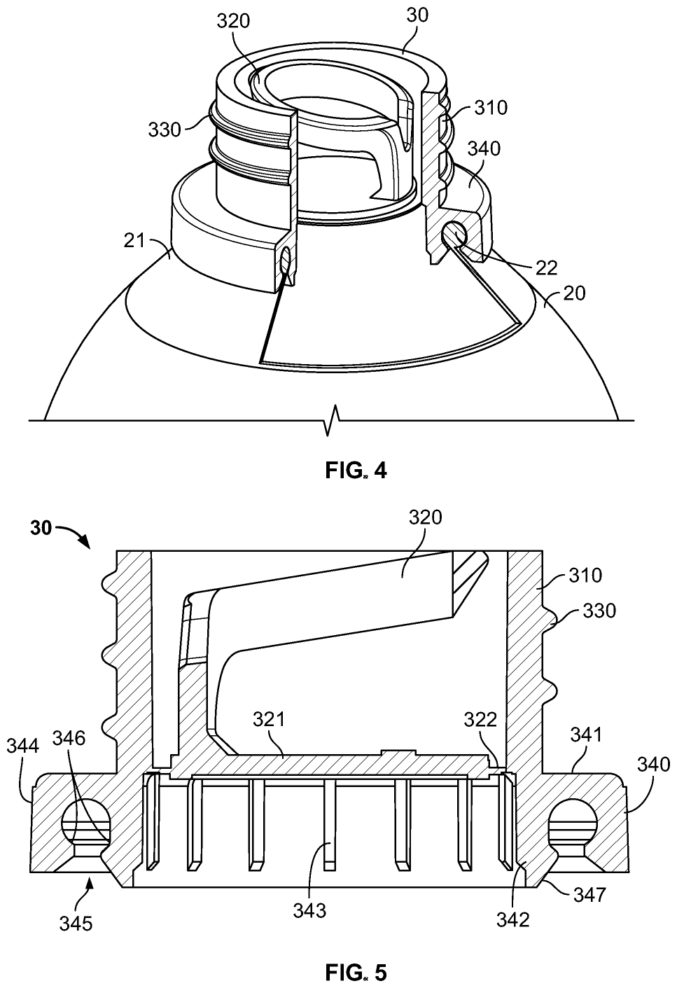

Top panel 341 also accommodates an outer skirt 344 extending downward in a substantially parallel direction to that of extension 342, defining a fitment gap 345. Beads or resilient coupling protrusions 346 form a narrowed mouth to the gap 345, such that the protrusions 346 facilitate snap-fitting or coupling the flange 22 into the gap 345. Thus, gap 345 should have contour along its upper reaches that matches or accommodates the shape of the flange 22 (i.e., bulbous as shown in FIG. 4). The extension 342 may further include a tapered edge 347 extending axially downward further than the terminal edge of skirt 344, so as to facilitate locating and coupling to the container 20. In some aspects edge 347 and/or the inner facings defined by cylinder 310, 342 could be tapered to accommodate and/or couple to an extension piece fitted on another component, such as the funnel 340.

Panel 321 may be formed integrally with the top end 310 and/or flange section 340. A thinned, frangible bridge 322 ensures that panel 321 may be removed by pulling upward on the handle 320. This provides evidence as to when the closure element 30 has first been opened by an end user. In one aspect, handle 320 is formed as a partial or complete circular loop to better facilitate grasping, while an axial extension provides clearance between the grasping end and the panel 321.

The threads 330 formed on the outer surface of the top end 310 should be of an appropriate pitch and dimension to accommodate corresponding threads formed on the refill funnel 40 and, separately, the dispensing elements 50. A cap 350 is also provided or integrally formed on/coupled to the closure 30. Cap 350 could include a frangible, tamper evident ring or feature that cooperates with a separate feature formed on the end 310 immediately beneath the threads 330. In some aspects, cap 350 could be affixed to the end of the handle 320 or some other portion of the closure 30 by its own frangible bridge.

In function, cap 350 is configured to seal the open top end 310 to prevent the loss or escape of fluids from the container. As such, cap 350 may include any number of other features commonly used in this field.

Refill funnel 40 is configured to attach to the closure element 30 so as to receive and facilitate fluids to refill the container 20. Fluids enter the funnel at its opening 421 and exit via a neck opening 431, all driven by gravity and in a manner well understood within this field.

Funnel 40 includes an attachment ring 410 having an inner diameter that fits around the container neck 21. In some aspects, the outer diameter of the flange 340 is larger than the inner diameter of the ring 410 so as to ensure the funnel 40 remains attached to the container 20 after the closure 30 is mounted onto it. Additionally or alternatively, resilient retention tabs 411 can extend radially inward on the inner facing of the ring 410 so as to allow for attachment and removal of the ring 410 and funnel 40 even after the closure 30 has been mounted. As above, the tabs 411 collectively define an inner circumference that is smaller than outer diameter proximate flange 340, although the resilient nature of the tabs 411 would allow them to deflect and disengage when sufficient upward/downward force is applied. Tether 412 ensures the ring 410 stays affixed to the mouth section 420 and neck section 430.

Mouth 420 is formed as a tapering and/or frusto-conical bowl along its inner surface so as to provide a larger target area for pouring fluids into the funnel 40 (and, when it is screwed onto the container 20, into the container itself). Mouth section 420 preferably presents a smooth surface, although a contoured lip 422 could be provided at the top edge, preferably on the opposite side of the funnel 40 as the ring 410.

Neck section 430 has a smaller inner diameter in comparison to any point in the mouth 420. Knurling or other grip enhancements 432 could be provided on the outer surface of section 430. Along the inner surface, threads 433 are formed in a manner that allows for a sealed fit between the funnel 40 and the closure 30 when the threads 330, 433 are engaged.

Various dispensing elements 50a, 50b, 50c can be provided. In one aspect, trigger sprayer head 50a includes a threaded attachment element 51 that couples to the top end 310 of the closure 30 (when the cap 350 is displaced). Sprayer 50a may be of any variety and function, so long as it includes an appropriate means of coupling to the closure 30.

Additionally or alternatively, dispensing funnel 50c could also be provided. Similar to refill funnel 40, dispensing funnel 50c may include an attachment ring 54 having the same features and function associated with ring 410 above. Also, a threaded attachment element 51 may be integrally formed at the receiving mouth of funnel 50c.

Yet another possible dispensing element is dosing cup 50b. Cup 50b is configured to have a diameter that allows for mounting to the container 20 so as to receive and conceal the closure 30 and its associated elements. In a separate aspect, cup 50b conforms and couples to funnel 40. Attachment features 57 can be formed along the open edge of the cup 50b and/or into bottom panel to connect to any of the aforementioned elements, with cooperating features proximate the edges of mouth 420, neck 430, neck 21, and/or top-facing surfaces of end 310 (e.g., bead and groove, slot and tab, etc.). Cup 50b can also be formed with a contoured lip 56 which facilitate pouring, with lip 56 also serving as a locating feature relative to lip 422. Indicia of dosing or volume may be imprinted, molded, or inscribed on the inner and/or outer sidewall surfaces of the cup 50b.

An alternative for the attachment of closure 30 can be found in U.S. Pat. No. 7,946,436, which is incorporated by reference herein. Rather than snap-fitting to the container 20, a crimped, “beverage can” style method is employed, so that the top edge of the neck 21 is folded around a rib or flange formed on the top facing of end 310. This approach eliminates the need for flange 22 on the container. Also, flange section 340 is comparatively thinner, as it no longer requires an annular cavity for the snap fitting of container edge 22, thereby resulting in a concurrent reduction or elimination of structural complexity and costs.

With specific reference to FIG. 7 (note that reference numerals not specifically disclosed here possess the same features as described in connection with FIG. 4 above), alternative closure 30a includes a top end 310 with an annular rib 311 partially or completely disposed on its top facing. The terminal edge of the container neck 21 is curled or crimped around rib 311 to secure the closure to the container.

Notably, this arrangement requires the closure to be seated atop the container 20 on its outer facing so as to leave threads 330 exposed. As such, incorporation of frangible panel 321 is not preferred. Nevertheless, cap 350 can be provided to seal the container 20, and this configuration would be particularly amenable to incorporating a tamper-evident, frangible ring or strip on the lower end of the cap 250 so as to cooperate with indent 341. In this manner, a similar overall purpose is served. Also, funnel 40 and/or dispensing elements 50 can still be screw fitted to closure 30a as is described above.

Ultimately, the use of a snap fitting or crimped edge can be dictated by the diameter of the opening in the container, the materials used in the container, and the ease with which crimping or snap fitting can be employed in the production process. Notably, if a crimped edge of the container is provided on the top facing of end 310, the transition section in the funnel 40 (i.e., from mouth 420 to neck 430) can be provided with a cooperating flange or abutment piece to better locate, align, and seat the funnel 40 on top of the closure 30 as the two or screwed together.

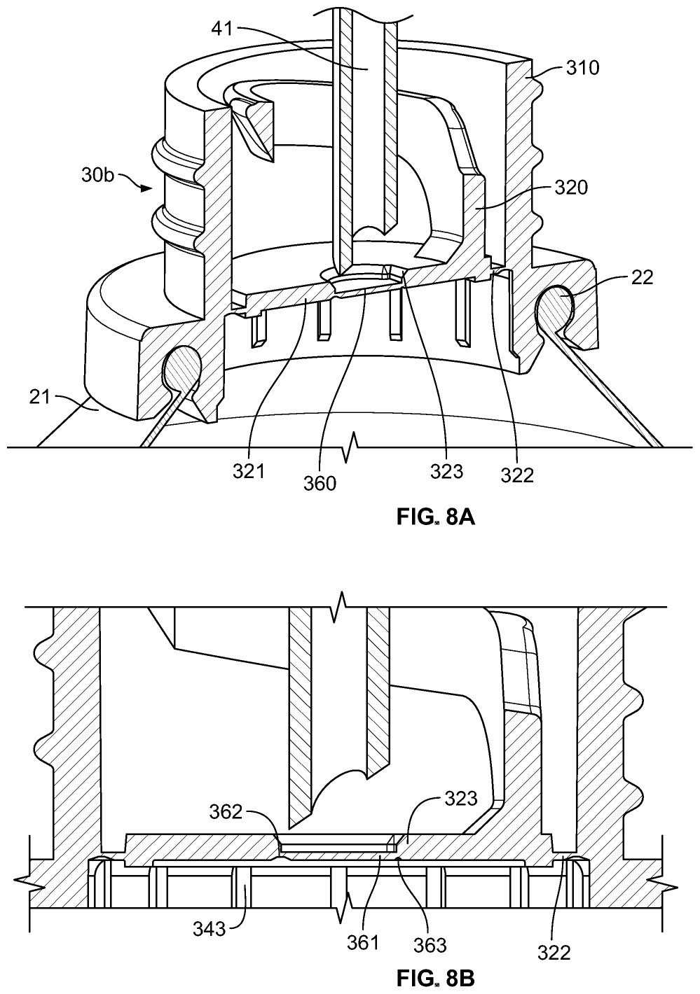

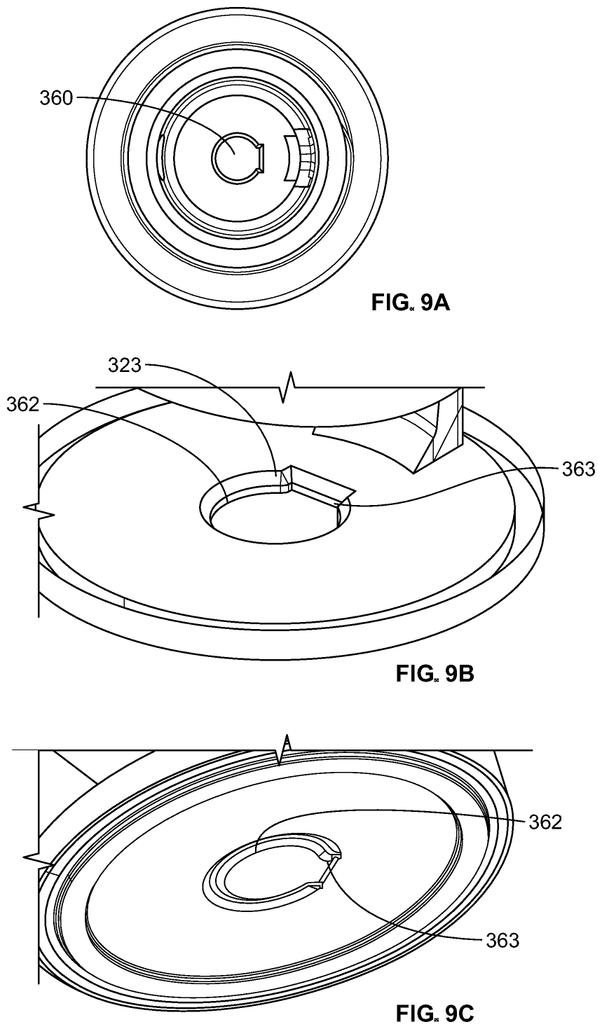

Yet another alternative construction for closure 30b relates to how the panel 321 and frangible bridge connections 322 are formed. Specifically, in addition to or in place of the structure described and depicted in FIG. 5, a tethered hinge panel 360 may be provided in the central region of the panel 321, as shown in FIGS. 7A through 8C. This tethered hinge structure accommodates a piercing element, such as the hollow, pointed dip tube 41 associated with trigger sprayer 40 (or some other cylindrical member, preferably formed with a pointed or wedged edge on its lower facing).

In this manner, the trigger sprayer 40 (or other dispensing element) is able access and draw fluid from the container 20 without removal of the entire panel 321. The arrangement could also eliminate the need for handle 320 (although refilling of the system 10 would be slower to the extent the funnel neck 430 delivers greater volume than can be accommodated by the opening created as tethered hinge panel 360 is displaced from the remainder of panel 321). It is also possible to taper and angle the neck opening 431 to cooperate with the tethered hinge 360.

This arrangement can be particularly useful for retail or e-commerce where it might be desirable to sell the entirety of the system 10 while minimizing or eliminating loose parts. To that end, a threaded mounting post or snap-fitting indent can be formed on a surface of the trigger sprayer or other dispensing element to secure the cap 350.

With particular reference to FIG. 8B, the tethered hinge 360 includes thinned circular, oval, or polygonal panel 361 (relative to the thickness of panel 321). An arcuate groove(s) 362 disposed connects the panels 321, 361 on their top and/or bottom facings. Groove 362 defines the shape of panel 361 and comprises greater than one half of its perimeter. In a preferred arrangement, groove 362 is C-shaped and circumscribes between 50 to 90% of the circumference of panel 361.

The remaining connector section 363 between panels 321, 361 is also thinner in comparison to the thickness of the panel 361 but still thicker in comparison to the thickness at the groove section 362. This arrangement imparts a preferential breaking point so that panel 361 detaches along the grooved section 361 but remains intact at section 363. In this manner, the panel 361 may pivot downward to create a small opening but with the panel 361 remaining tethered to the closure 30b (by way of section 363).

To facilitate the leading or cutting edge of the dip tube 41, a curved, sloping, or frusto-conical edge finish 323 can be disposed around the inner periphery of panel 321. In operation, edge 323 serves to locate and “funnel” the dip tube 41 onto the panel 361. Along its interface with the connector section 363, edge 323 (and connector section 363 itself) can be formed along a comparatively straight line (relative to groove 362), as this will further encourage the creation of a tethered hinge.

In closure 30b, frangible bridge 322 should be comparatively stronger than that of groove/arcuate section 362. In some aspects, the thickness of bridge 322 is the same or greater than that in connector section 363. Notably, the inclusion of ribs 343

References to coupling in this disclosure are to be understood as encompassing any of the conventional means used in this field. This may take the form of snap- or force fitting of components, although threaded connections, bead-and-groove, and slot-and-flange assemblies could be employed. Adhesive and fasteners could also be used, although such components must be judiciously selected so as to retain the underlying design goals inherent to the assembly.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

All components should be made of materials that are chemically inert and capable of contacting oils and other fluids for extended periods of time without degradation, while still possessing sufficient. structural integrity. The materials should also be selected for workability, cost, and weight. Common polymers amenable to injection molding, extrusion, or other common forming processes should have particular utility for the funnel, closure, and/or dispenser (e.g., trigger sprayer), while metallic containers having standard sizes and neck finishes are already proven within the industry to accommodate oils, lubricants, cleaners, and other fluids that would be particularly useful with the inventive system. Nevertheless, it will be understood that the container itself may also be formed from polymeric materials possessing the qualities noted above.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

1. A refillable container and dispensing system comprising:
a container having a neck;
a closure element having a hollow cylindrical shape with an attachment feature including threads disposed on an outer facing at a top end of the closure element and a flange disposed beneath the top end having an annular recess configured to couple to the neck; and
a refill funnel having a mouth at a top end with a wider inner diameter in comparison to a neck at a bottom end, wherein a cooperating attachment feature disposed on an inner surface of the neck and configured to selective couple to the attachment feature of the closure element.

2. The container and dispensing system of claim 1 wherein the refill funnel includes an integrally formed attachment ring, said attachment ring captured on the neck by the closure element.

3. The container and dispensing system of claim 1 or claim 2 further comprising a dispensing element having a cooperating attachment feature selectively coupling to the attachment feature of the closure element.

4. The container and dispensing system of claim 3 wherein the dispensing element is at least one selected from the group consisting of: a trigger sprayer, a dispensing funnel, and a dosing cup.

5. (canceled)

6. (canceled)

7. The container and dispensing system of claim 1 wherein a removable panel spans an inner diameter of the closure so as to seal the container when the closure is coupled to the container.

8. The container and dispensing system of claim 7 wherein the removable panel is circular, oval, or polygonal.

9. The container and dispensing system of claim 8 wherein a finishing edge is formed at a periphery of the removable panel.

10. The container of claim 9 wherein the periphery of the removable panel includes a tether hinge and a frangible arcuate section.

11. The container of claim 10 wherein a handle is attached to the removable panel.

12. The container of claim 8 wherein the periphery of the removable panel includes a tether hinge and a frangible arcuate section.

13. The container of claim 7 wherein a handle is attached to the removable panel.

14. A refillable container and dispensing system comprising:
a container having a neck;
a closure element having a hollow cylindrical shape with an attachment feature disposed on an outer facing and one or more ribs formed on a top facing of the closure element and wherein a terminal edge of the neck is crimped or curled around the one or more ribs to couple to the closure to the container; and
a refill funnel having a mouth at a top end with a wider inner diameter in comparison to a neck at a bottom end, wherein a cooperating attachment feature disposed on an inner surface of the neck and configured to selective couple to the attachment feature of the closure element.

15. The container of claim 14 wherein the attachment feature and the cooperating attachment features comprise a rotatable, threaded connection.

16. The container and dispensing system of claim 14 wherein the refill funnel includes an integrally formed attachment ring, said attachment ring captured on the neck by the closure element.

17. The container and dispensing system of claim 14 further comprising a dispensing element having a cooperating attachment feature selectively coupling to the attachment feature of the closure element.

18. The container and dispensing system of claim 17 wherein the dispensing element is at least one selected from the group consisting of: a trigger sprayer, a dispensing funnel, and a dosing cup.

19. The container and dispensing system of claim 14 wherein a removable panel spans an inner diameter of the closure so as to seal the container when the closure is coupled to the container.

20. The container and dispensing system of claim 19 wherein the removable panel is circular, oval, or polygonal.

21. The container and dispensing system of claim 19 wherein the removable panel includes a tether hinge and a frangible arcuate section at a peripheral edge of the removable panel.

22. The container and dispensing system of claim 19 wherein the removable panel includes a finishing edge formed at a periphery of the removable panel.
